(19) United States
(12) Patent Application Publication
(10) Pub. No.: US 2004/0075727 A1
(43) Pub. Date: Apr. 22, 2004

(54) Printer apparatus and method

(76) Inventors: Ezequlel Jordl Rufes, Barcelona (ES); Angel Cercos, Barcelona (ES); Joaqulm Veclana, Barcelona (ES)

Correspondence Address: HEWLETT-PACKARD COMPANY, Intellectual Property Administration, P. O. Box 272400, Fort Collins, CO, 80527-2400, US

(21) Appl. No.: 10/274,201

(22) Filed: Oct. 17, 2002

(51) Int. Cl. B41J 2/01

(52) U.S. Cl. 347/104

(57) ABSTRACT

A printer device comprising a print zone and one or more printheads arranged to reciprocally traverse said print zone and to print on print media located in said print zone, said device being adapted to receive first and second media input trays, said device being arranged to feed first and second sheets of print media to said printzone from said first and second trays respectively and to print on said first and second sheets substantially simultaneously.

### FIELD OF THE INVENTION

The present invention relates generally to printer devices, particularly but not exclusively, to an inkjet printer having an improved print media feed system.

### BACKGROUND OF THE INVENTION

It is generally known to use printers, such as laser printers and inkjet printers, to print on pre-cut sheets. Inkjet printer devices, for example, generally incorporate one or more inkjet cartridges, often called “pens”, which shoot drops of ink onto a page or sheet of print media. For instance, two earlier thermal ink ejection mechanisms are shown in U.S. Pat. Nos. 5,278,584 and 4,683,481, both assigned to the present assignee, Hewlett-Packard Company. The pens are usually mounted on a carriage, which is arranged to scan across a scan axis relative to a sheet of print media as the pens print a series of individual drops of ink on the print media forming a band or “swath” of an image, such as a picture, chart or text.

In such printers, pre-cut sheets are generally stored in an input tray or sheet feeder prior to being printed on. However, such devices are generally arranged to work only with a given size of print media. If it is desired to use media of a different size, it may in some cases be fed manually into the printer via a bypass system. However, such processes and generally slow and cumbersome, which may adversely affect the throughput achievable by a given printer. Throughput is generally measured as the number of pages of a given size that a printer may ink in a given time. Over recent years, the importance placed on the throughput of printers has risen dramatically.

Therefore, it would be desirable to provide an improved printer device and a method of operating such a device that addresses the problems associated with the prior art.

### SUMMARY OF THE INVENTION

According to the present invention there is provided a printer device comprising a print zone and one or more printheads arranged to reciprocally traverse said print zone and to print on print media located in said print zone, said device being adapted to receive first and second media input trays, said device being arranged to feed first and second sheets of print media to said print zone from said first and second trays respectively and to print on said first and second sheets substantially simultaneously.

By printing on the two sheets at the same time, various advantaged may be realised. In scanning type printers, such as many inkjet printers, it generally takes approximately the same length of time to print a swath across the entire width of the print zone of the printer as it does to print a swath across the width of a single sheet which is narrower than the print zone. By locating two sheets of print media adjacent to one another in the print zone and printing on both in a given pass of the scanning printhead, the throughput of the printer of the present embodiment may be considerably greater than a comparable printer of the prior art.

Furthermore, in this manner, a greater degree of flexibility is realised relative to comparable prior art printers. For example, by accommodating two or more media input trays of different sizes, the range of sizes of print media sheets that may be fed automatically is increased. Additionally, the range of media types that may be fed without user intervention being required may also be increased. In this manner, the cumbersome manual loading of sheets via the bypass system may be avoided. This may reduce loading times and increase throughput.

Furthermore, the increased choice of available sheet sizes for use with a given print job allows the media sheet size to be better matched to the size of the image to be printed print on. This in turn may allow the amount of post printing operations to be reduced. For example, if one or more small images are printed by a prior art printing device on a relatively large sheet of print media, it may be necessary to cut the print media sheet in order to split one image from another. It may also be necessary to trim the print media sheet to the desired dimensions; for example, the dimensions of an image printed on it. Such cutting and trimming operations waste a significant amount of print media and reduce the throughput capability of the printer.

Preferably, the first and second input trays are arranged in a side-by-side arrangement in use in the printer.

Preferably, the sheets from the first and second input trays are fed to the print zone at the same time. In this manner, this throughput of the printer may be increased. Preferably, this is achieved using independent sheet picking mechanisms, although a common non-independent sheet picking mechanism may be used to pick the two sheets at the same time.

Preferably, the input trays are largely passive in operation. That is to say that the sheet picking and feeding actuation is derived from the mechanisms of the printer. In this manner, simple and inexpensive input trays may be used in embodiments of the present invention. Thus, a single printer based picking and feeding mechanism may be used to pick and feed sheets from two or more input trays. In this manner, relatively expensive picking and feeding mechanisms need not be duplicated in respect of each input tray. However, the skilled reader will appreciate that sheet feeder devices, with their own integrated sheet picking and feeding mechanisms may instead be used in certain embodiments of the invention.

Advantageously, according to preferred embodiments, the addition of extra input trays does not cause an increase in the size of the printer. Furthermore, the present invention allows great flexibility in the use of printers according to embodiments of the invention. Furthermore, the present invention may be applied to certain existing printers, thus providing such extra flexibility without requiring significant modification of the printers.

The present invention also extends to the method corresponding to the apparatus. Furthermore, the present invention also extends to a computer program, arranged to implement the method of the present invention.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIGS. 1a-c show a perspective and plan views of an inkjet printer according to a first embodiment of the present invention;

FIGS. 1d-f show a perspective and plan views of an inkjet printer according to a first embodiment of the present invention with one input tray removed;

FIG. 2 shows a partial, sectional view of the printer and input tray shown in FIG. 1;

FIGS. 3a and 3b illustrate the actuation of the sheet feeding mechanism of the printer of FIG. 1;

FIGS. 4a and 4b show schematic illustrations of the use of clutches for independent or semi-independent activation of different input trays; and,

FIG. 5 illustrates three modes of printing with the printer of FIG. 1.

### DETAILED DESCRIPTION OF THE INVENTION

There will now be described, by way of example only, the best mode contemplated by the inventors for carrying out the invention.

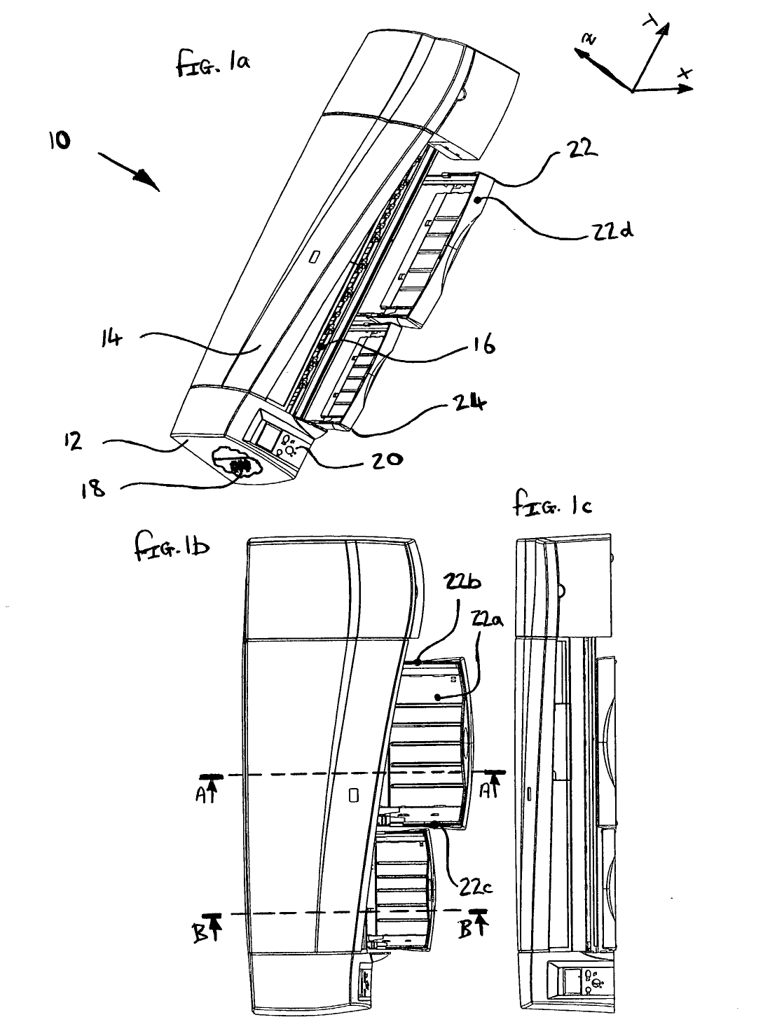

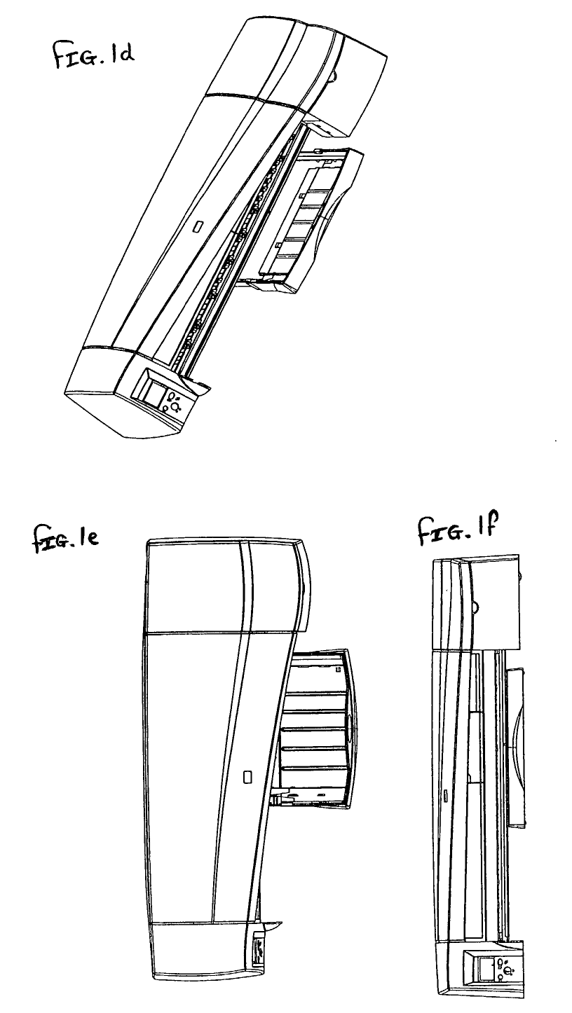

Referring to FIG. 1a, a perspective view of an inkjet printer 10 according to the present embodiment is shown. The printer 10 may be used for printing conventional engineering and architectural drawings, as well as high quality photographs or posters. In this example, the printer 10 is of the type designed to be supported on a surface such as a desk top. The printer has a housing or casing 12, typically manufactured from a plastics material. The casing has a lid 14, which is illustrated in the closed position in the figure. Under the lid, is the print zone 16 of the printer, which may be partially seen in the figure.

The printer has a printer controller, illustrated schematically as a microprocessor 18, that receives instructions from a host device, which is typically a computer, such as a personal computer or a computer aided drafting (CAD) computer system (not shown). The controller 18 has associated memory (not shown), which includes ROM and RAM. Image data, which is downloaded from a host device, may be stored in the RAM prior to being printed. The ROM stores operating instructions, which the controller 18 accesses in order to carry out the functions of the printer. The printer controller 18 may also operate in response to user inputs provided through a key-pad and status display portion 20, located on the exterior of the casing 12.

As can be seen in FIG. 1a, the printer has two media input trays 22 and 24. The two input trays are located side by side, arranged along the Y-axis of the printer. The X, Y and Z-axes of the printer are illustrated in FIG. 1 with respect to FIG. 1a. The relative positions of the two trays may be more clearly seen from FIGS. 1b and 1c, which show plan and front elevation views of the printer 10, respectively.

As can be seen from the figures, the input trays 22 and 24 are of different sizes and are arranged to accommodate different sizes of print media. In the present embodiment, input tray 22 is arranged for use with print media of size A3 and input tray 24 is arranged for use with print media of size A4. In the case of both trays, the smaller dimension of the print media is aligned parallel to the Y-axis of the printer when loaded in its respective tray. As can be seen most clearly from FIG. 1c, the positions of the two input trays 22 and 24 in the printer in the Z-axis are approximately equal. In the present embodiment, each of the trays is used to hold plain paper type print media, although other types of print media may also be used.

Each of the input trays 22 and 24 is of conventional design. Accordingly, each may be removed in order that more print media may be added. FIGS. 1d-f, illustrate the printer 10 with one tray removed, in this case tray 24. The views shown in FIGS. 1d-f correspond to those shown in FIGS. 1a-c, respectively.

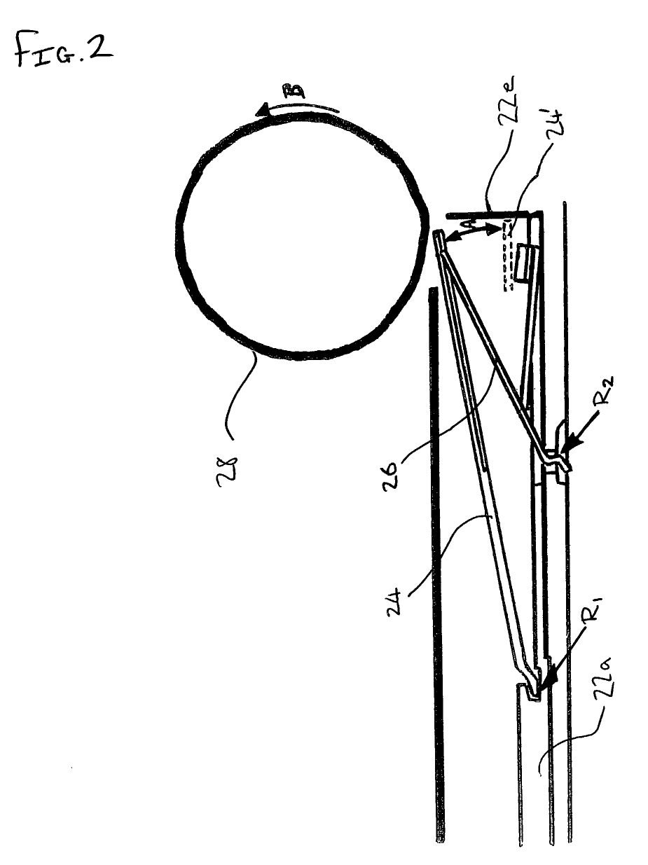

Since the structure and operation of input trays is well understood in the art of inkjet printers, the input trays 22 and 24 will not be described in detail. However, their structure will now be briefly described with reference to FIGS. 1a-f and FIG. 2. FIG. 2 is a partial, sectional view of the printer and the input tray 22, taken along the lines A-A (shown in FIG. 1b). However, since the structures and functions of the input trays 22 and 24 are substantially the same, the skilled reader will appreciate that in the present embodiment an equivalent partial sectional view of the printer, taken along the lines B-B (also shown in FIG. 1b), would look similar.

As can be seen from FIG. 1a, for example, each tray has a base portion for supporting one or more sheets of pre-cut print media (such as transparencies or paper) in a stack. In the case of input tray 22, the base portion is referenced 22a. The trays also each have four retaining walls arranged to secure the media stack. In the case of tray 22, the two side retaining walls are referenced 22b and 22c and the forward and rearward retaining wall are referenced 22d and 22e, respectively. The rearward retaining wall 22e is shown in FIG. 2.

As can be seen in FIG. 2, a pressure plate 24 and a pressure plate lever 26 are located in part of the base portion 22a of the input tray near the rearward retaining wall 22e. The pressure plate and a pressure plate lever are respectively adapted to rotate about points referenced R₁ and R₂, as is illustrated by the arrow “A” in the figure. In the figure, the pressure plate and the pressure plate lever are illustrated at an extreme rotational position in which they are raised up relative to the base portion 22a. The position of the pressure plate is illustrated in a second extreme position in dashed line, referenced 24′. In the second extreme position, the pressure plate and the pressure plate lever lie approximately parallel with the media supporting surface of the base portion 22a.

When a paper stack is present in the tray, the sheets of paper overlie the pressure plate. When no paper feed operation is being undertaken, the pressure plate and the pressure plate lever are located in the second rotational position, shown in dashed line. In this position, the paper stack held in the tray lies approximately parallel with the base portion 22a of the tray.

When a paper feed or sheet picking operation is required, the pressure plate and the pressure plate lever are moved from the second rotational position towards the first rotational position. In this manner, the upper surface of the top sheet of the stack is brought in to contact with a pick roller 28. This sheet is then fed from the tray by the rotation of the pick roller 28 in the direction of the arrow “B” in the figure. The sheet is then entrained about the pick roller 28 with the aid of a cleanout mechanism (not illustrated). In this manner, the sheet is brought around in a U-direction to travel in the opposite direction towards the print zone 16. The sheet is then stopped in the print zone 16 in order to allow a printing operation to be performed, as is described more fully below.

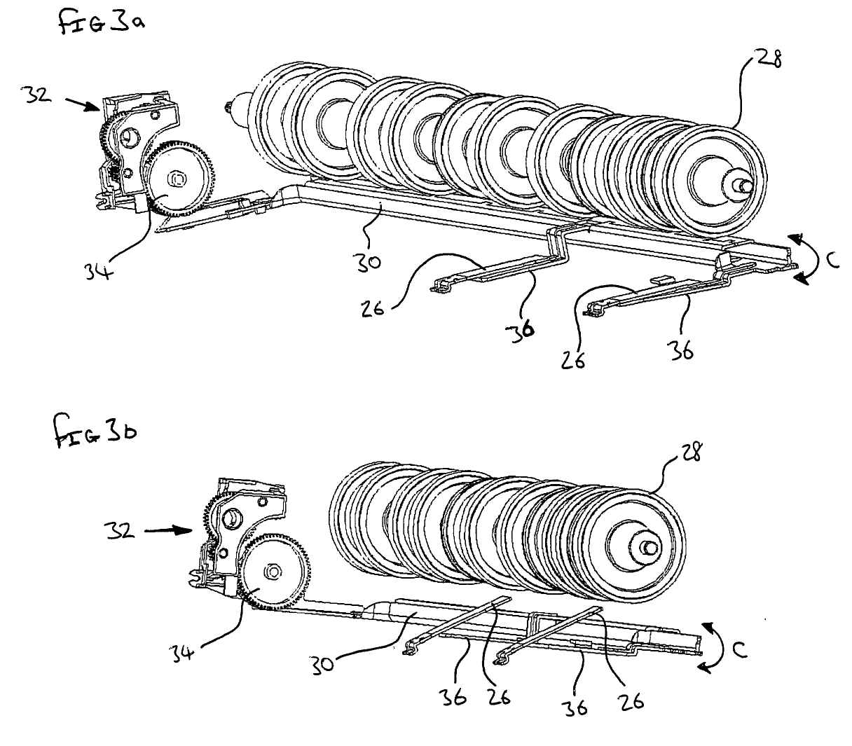

Referring to FIGS. 3a and 3b, an example of a suitable mechanism, located in the printer 10, for actuating the pressure plate and the pressure plate lever of the media input tray 22 is schematically illustrated. In the figures, a “P-lift axis” 30 is shown. In the present embodiment, the P-lift axis is a bar that lies parallel to and below the pick roller 28. The P-lift axis is arranged to rotate about its longitudinal axis, as is illustrated by the arrow “C” in the figure. A shifter mechanism 32 is located at one end of the P-lift axis. The shifter mechanism 32 has an arrangement of gears driven by a drive motor (not shown), which in turn drives a “P-lift cam” 34. The “P-lift cam” 34 is arranged to rotate in a single direction and to cause the P-lift axis to rotate, by virtue of a mechanical linkage, a limited distance about its longitudinal axis, first in one direction and then in the reverse direction, again for a limited distance. This may be achieved using a conventional cam drive mechanism.

As can be seen from the figures, a number of P-lift elements 36 are connected to the P-lift axis. Each of these elements, in use, is located underneath a corresponding pressure plate lever 26 of one of the two trays 22 and 24. In this manner, when the P-lift cam drives the P-lift axis, the P-lift elements 36 rotate about the longitudinal axis of the P-lift axis. Thus, as the P-lift cam drives the P-lift axis in the first direction, the P-lift elements 36 rotate through corresponding apertures in the base portion (e.g. 22a) of the tray in question, raising the pressure plate levers of the trays to enable a sheet feed operation. FIG. 3b illustrates the P-lift elements and the P-lift levers in the second rotational position, corresponding to that shown in FIG. 2, where a page feed operation is being undertaken. As the P-lift cam subsequently drives the P-lift axis in the reverse direction, the P-lift elements 36 rotate in the opposite direction lowering the pressure plate levers. FIG. 3a illustrates the P-lift elements and the P-lift levers in the first rotational position, in which they are approximately parallel with the base portions of the trays. Thus, this corresponds to the position of the mechanism when no page feed operation is being undertaken.

Since the height to which the paper stack must be lifted, in order to bring the topmost page into contact with the pick roller 28, varies with the height of the paper stack held in the tray (i.e. the number and thickness of the sheets), the P-lift elements 36 are made from a resilient material such as sheet steel. In this manner, for a fixed degree of rotation of the P-lift axis, a page may be successfully fed from a full or an empty tray. Thus, in the case of feeding from a full tray, where a reduced lift of the pressure palate is required, the flexibility of the P-lift elements 36 absorbs the extra rotation of the P-lift axis. In alternative designs, spring may be used to allow the P-lift axis to be lowered relative to the pressure plate levers to absorb the extra rotation of the P-lift axis.

In the FIGS. 3a and 3b, only two P-lift elements are illustrated. In practice, this may be sufficient for a single media input tray. Thus, it will be appreciated that further P-lift elements may be added to the structure illustrated in FIGS. 3a and 3b in order to actuate both input trays 22 and 24. However, in such an embodiment, the operation of each input tray will generally be dependent upon the operation of the other; i.e. that it may not be possible to select to feed a sheet from one tray and not the other.

However, in the present embodiment, it is preferably possible to select to feed a sheet from input tray 22 without feeding a sheet from input tray 24 and also possible to select to feed a sheet from input tray 24 without feeding a sheet from input tray 22. In addition to this, it is also preferable that sheets may be fed from both trays simultaneously. This may be achieved, for example, by duplicating the mechanism shown in FIG. 3 including the shifter mechanism, P-lift cam, P-lift axis and P-lift elements; i.e. using a mechanism corresponding to that shown in FIG. 3 to operate input tray 22 and a separate a mechanism, again corresponding to that shown in FIG. 3, to operate input tray 24. Thus, full independent operation between the input trays is achieved. In this case, a single pick roller may be used, which spans both input trays. The choice of which tray, tray 22 or tray 24, to feed from in a given instant, or indeed whether sheets should be fed from both trays simultaneously may be made by the controller, or by a manual user selection.

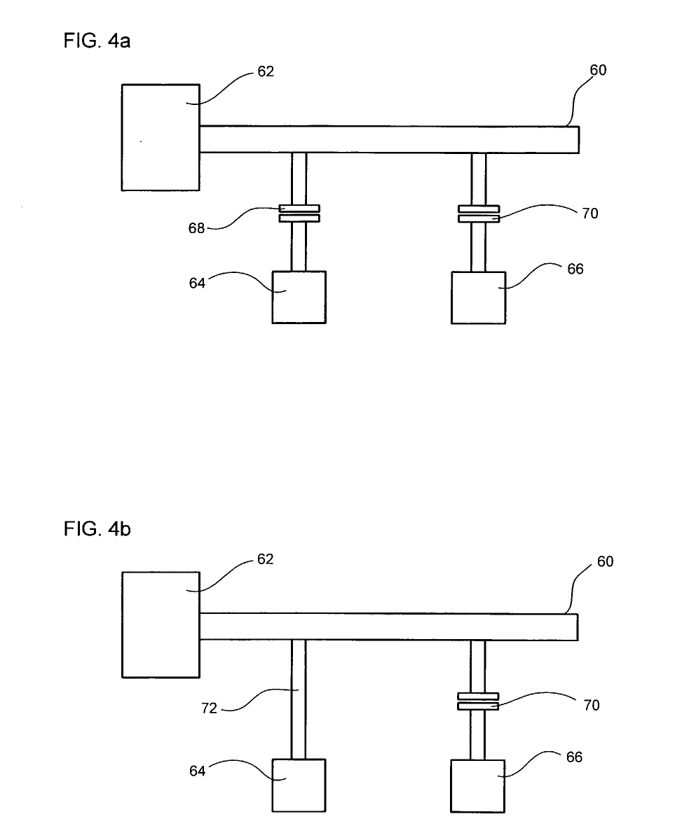

Alternatively, the P-lift elements corresponding to the two trays may be operated from a common P-lift axis or shaft. An example of such an arrangement is schematically illustrated in FIG. 4a. In this example, a common shaft 60, which corresponds to the P-lift axis of FIG. 3 is illustrated. The common shaft 60 is driven by a motor 62. The drive motor 62 may drive the shaft 60 in the same manner as the shifter and P-lift cam mechanism drives the P-lift axis shown in FIG. 3. Also shown in FIG. 4a are the pick mechanisms 64 and 66, which allow sheets to be picked from respective input trays. The pick mechanisms 64 and 66 may correspond to the P-lift elements and the pressure plate and pressure plate lever associated with the respective trays. As can be seen from FIG. 4a, each of the pick mechanisms 64 and 66 is connected to the shaft 60 by a clutch, 68 and 70 respectively. The clutches may be of any suitable type and may be independently controlled by the controller. In this manner, when either clutch is in a first operative state, a sheet may be fed from the associated input tray, when a picking operation is implemented. However, when the clutch is in a second operative state, the feeding mechanism of the associated tray is decoupled from the shaft. Thus, a sheet will not be fed from the associated input tray when a picking operation is implemented.

FIG. 4b illustrates a further alternative, in which a clutch 70 may be used to determine whether or not the pick mechanism 66 picks a sheet of print media when a picking operation is implemented. However, as can be seen from the figure, the pick mechanism 64 is directly coupled to the shaft 60 (i.e. without a clutch). In this manner, a sheet will always be fed from the tray corresponding to the pick mechanism 64 (assuming that the tray contains print media) when a picking operation is implemented.

The skilled reader will appreciate that further methods of arranging fully independent, partially independent, or wholly dependent operation between the trays of the printer may alternatively be used. For example, instead of employing a single pick roller which spans both trays, a separately controllable roller may be associated with each tray. In this manner, the operation of the P-lift system (axis, elements, levers etc.) may be common for each of the trays, yet allow the selection of which tray or trays to be picked from to be made independently.

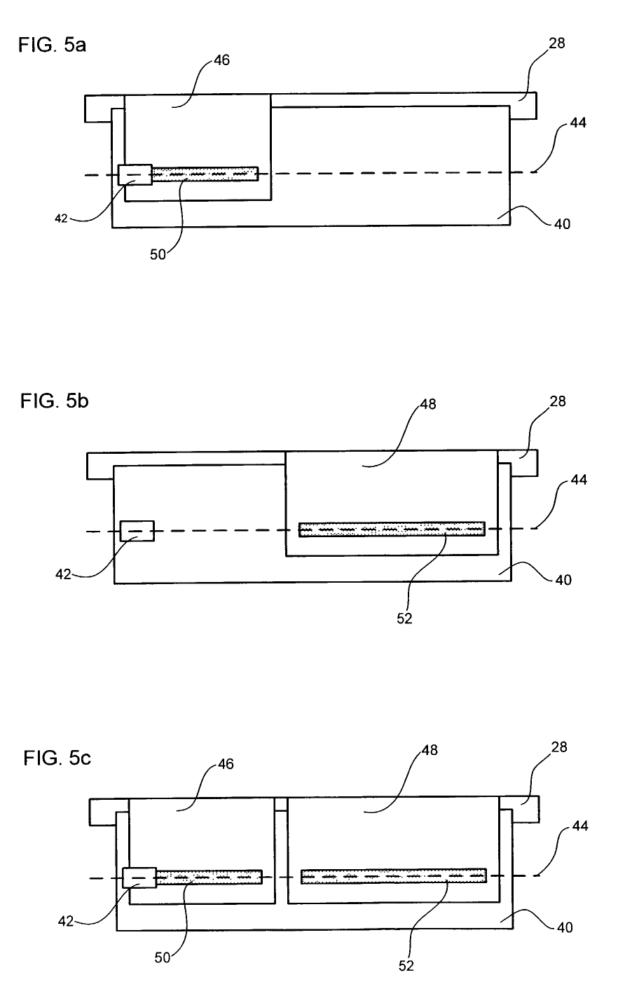

Referring now to FIGS. 5a-5c, the modes of printing of the printer according to the present embodiment of invention will now be described.

Each of FIGS. 5a-5c illustrates a simplified, partial plan view of the printer according to the present embodiment when printing. The figures illustrate the pick roller 28 which, as has been discussed above, is arranged to pick one or more sheets at a time and with the aid of the cleanout mechanism, to feed the sheet(s) to a print platen 40. The print platen 40 of the printer is adapted to support a sheet of print medium whilst it is being printed on.

The printer 10 of the present embodiment has one or more conventional inkjet cartridges (not shown), for example thermal or piezoelectric inkjet cartridges supported in a carriage 42. The carriage is propelled by a conventional carriage drive motor (not shown) along a scan axis 44 spanning the print zone of the printer, under the control of the controller. The controller controls the inkjet cartridges to eject ink at selected times in order to print a desired image. Commonly assigned U.S. Pat. No. 5,835,108, entitled “Calibration technique for misdirected inkjet printhead nozzles”, which describes such an inkjet system in more detail is hereby incorporated herein by reference in its entirety. However, it will be appreciated that any suitable printing engine may be used in other embodiments of the present invention.

Referring to FIG. 4a, a single sheet 46 is illustrated. In the present example, the sheet of print media 46 was selectively picked from the tray 24. That is to say that whilst it was selected to pick a sheet from the tray 24, it was also selected not to pick a sheet of print media from the tray 22. This independent selection process may be implemented in any suitable manner, such as has been described above. Since the sheet 46 is fed around the pick roller 28 and along the platen 40 in a direction parallel to its longer sides (i.e. along the X-axis of the printer) it is supported on the left side of the platen 40 as viewed in the figure.

At the print zone, the print cartridges are arranged to print a swath of ink 50 on the sheet of print media in a single or multiple printing passes over the print zone. The sheet may then be incrementally advanced through the print zone by the sheet feeding mechanism. In this manner, further swaths of image content may be printed, building up a completed image. When the printing on the sheet is complete, the sheet is forwarded to the output position. In the present embodiment, the output position is above those parts of trays 22 and 24 which protrude from the printer body. Since the controller may store data in memory indicating that currently a sheet of print media from tray 24 only is present in the print zone, the controller controls the cartridges to print swaths of dimensions corresponding to the dimensions of sheet 46 alone and in the position of the print zone in which the sheet 46 is situated.

Referring to FIG. 5b, a further mode of operation of the printer of the present embodiment is shown. This mode is similar to the mode described with reference to FIG. 4a. However in FIG. 4b, a further sheet of print media 48 is shown. In this example, the sheet of print media 48 was selectively picked from the tray 22. That is to say that whilst it was selected to pick a sheet from the tray 22, it was also selected not to pick a sheet of print media from the tray 24, as has been described above. Since the sheet 48 is fed around the pick roller 28 and along the platen 40 in a direction approximately parallel to its longer sides (i.e. along the X-axis of the printer) it is supported on the right side of the platen 40 as viewed in the figure. As described above, the controller controls the cartridges to print swaths of dimensions corresponding to the dimensions of sheet 48 alone and in the position of the print zone in which the sheet 48 is situated.

Referring to FIG. 4c, yet another mode of operation of the printer of the present embodiment is shown. In this mode of operation, two sheets 46 and 48 of print media are fed approximately simultaneously, from the tray 22 and from the tray 24, respectively. Consequently, sheets 46 and 48 are present on the print platen at the same time. As is illustrated in the figure, the printer may then print on each of the sheets at the same time. Thus, in this mode of operation, the controller controls the cartridges to print swaths of dimensions corresponding to both the dimensions of sheet 46 and of sheet 48. These swaths are respectively referenced 50 and 52. As can be seen from the figure, the controller controls the position of swaths 50 and 52 such that they coincide with sheets 46 and 48, respectively. It will thus be understood that in the present mode of operation, in a given pass of the carriage across the print zone, the controller may control the cartridges to print on the first of sheets 46 or 48 to be traversed. The controller may then control the cartridges to leave a portion unprinted on. This portion may correspond to the space between the two sheets and any margins on the sheets which are left unprinted on. The controller may then control the cartridges to print on the second of sheets 46 or 48 to be traversed.

### FURTHER EMBODIMENTS

In the above description numerous specific details are set forth in order to provide a thorough understanding of the present invention. It will be apparent to one skilled in the art that the present invention may be practiced without limitation to these specific details. In other instances, well known methods and structures have not been described in detail so as not to unnecessarily obscure the present invention.

Although in the above-described embodiment, two media input trays were described, the skilled reader will appreciate that in other embodiments of the present invention, more than two media input trays could be used. For instance three or four, or more input trays could instead be used. This may allow three, four or more sheets to be picked and then printed on at the same time, offering even greater flexibility and throughput.

Furthermore, whereas in the above-described embodiment, the two media input trays arranged to hold A3 and A4 size paper, this need not necessarily be the case. The input trays of printers of other embodiments of the invention may instead be arranged to hold paper of larger or smaller sizes.

Although in the above-described embodiment, the two media input trays were arranged to hold sheets of print media of different sizes, the skilled reader will appreciate that this may be varied in other embodiments of the invention. For example, both media trays may be arranged to hold sheets of print media of the same size. For example, both may be arranged to hold A4 sheets, or alternatively, both may be arranged to hold A3 sheets. Furthermore, in embodiments where more than two media input trays are used, two or more, or indeed all of the media input trays may be arranged to hold sheets of print media of the same size.

Although in the above-described embodiment, the two media input trays were described as holding sheets of print media of the same type (in the example above, plain paper), the skilled reader will appreciate that this may be varied in other embodiments of the invention. For example, each of the two or more media trays used may be used to hold sheets of print media of the different types. Such types may include, plain paper, acetate, glossy or photo paper, to name but a few. It will also be understood that the different types of print media may be of the same or of different sizes.

It will also be appreciated that in certain embodiments of the invention, the input tray configuration may be changed by the user to suit his or her current printing requirements. For example, a printer adapted to use up to two A3 input trays simultaneously, may also be configured to accept up to three A4 input trays simultaneously. In this manner, a user may replace one or more of the A3 input trays with one or more of the A4 input trays; thus giving greater flexibility in use.

In the above-described embodiment, the printer was described as having two input trays. However, the skilled reader will appreciate that in other embodiments of the invention, two or more sheet feeders may instead be used. It will be understood that normally a sheet feeder is understood to contain an active sheet feeding mechanism as opposed to an input tray which contains a limited number of moving parts (if any), which are generally arranged to be actuated mechanisms associated with the printer.

Furthermore, the skilled reader will appreciate that although the above-described embodiment was described with reference to a desk-top inkjet printer, it will be understood that the present invention may be applied to a wide range of printers; such as wide format printers, copiers, and facsimile machines. Furthermore, the printing engine of such printers may employ printing technology other than inkjet technology. For example, dry electrophotographic or liquid electrophotographic technology.

The skilled reader will appreciate that the various further embodiments described herein may be used in combination with one or more of the remaining embodiments.

What is claimed is:

1. A printer device comprising a print zone and one or more printheads arranged to reciprocally traverse said print zone and to print on print media located in said print zone, said device being adapted to receive first and second media input trays, said device being arranged to feed first and second sheets of print media to said printzone from said first and second trays respectively and to print on said first and second sheets substantially simultaneously.

2. A device according to claim 1, wherein said printer has a first feed path arranged to feed sheets from said first and second input trays to said print zone, said device being arranged to feed sheets from said first and second input trays along substantially parallel first and second portions of said feed path.

3. A device according to claim 2, wherein said first and second input trays are in use arranged in a side by side arrangement in said device.

4. A device according to claim 1, wherein said device is further arranged to selectively activate the feeding of a sheet from either said first and/or said second input tray.

5. A device according to claim 4, wherein said device is arranged to receive a user input selecting said first and/or said second tray.

6. A device according to claim 4, wherein said device is arranged to select said first and/or said second tray automatically.

7. A device according to claim 5, wherein each said input tray has a substantially independent picking mechanism.

8. A device according to claim 7, wherein each said substantially independent picking mechanism comprises an independently operable picking roller.

9. A device according to claim 7, wherein each said substantially independent picking mechanism comprises an independently operable clutch adapted to activate or deactivate the feeding of a sheet from said corresponding input tray.

10. A device according to claim 4, wherein said first and/or said second tray is removable.

11. A device according to claim 4, wherein said first and said second tray are arranged to support sheets of print media having substantially the same dimensions.

12. A device according to claim 4, wherein said first and said second trays are arranged to support sheets of print media having different dimensions.

13. A device according to claim 4, wherein said device is arranged to print on first and second types of print media, said first and second input trays being arranged in use to input first and second types of print media, respectively.

14. A device according to claim 1, further comprising one or more further input trays.

15. A device according to claim 1, wherein said first and/or said second input trays comprise a sheet feeding mechanism.

16. A device according to claim 1, wherein said device is adapted to be operable with a third input tray, said third input tray being arranged to replace said first and/or said second input trays, said third input tray being arranged to store print media sheets of dimensions different to the sheets stored by at least one of said one or more replaced input trays.

17. An inkjet printer according to any preceding claim.

18. A printer device comprising a print zone and arranged to feed sheets of print media from first and second trays adapted to store sheets of print media, wherein said printer is arranged to print on first and second sheets of print media substantially simultaneously, said first and second sheets being fed from said first and second trays, respectively.

19. A printer device comprising a printzone and first and second input trays, said input trays being arranged such that first and second sheets of print media, originating from said first and second input trays respectively, may be fed to the printzone and printed on substantially in parallel.

20. A printer device comprising first and second media input trays and a print zone, said device being arranged to feed first and second sheets of print media from said first and second media input trays respectively and to print substantially simultaneously on said first and second sheets of print media in said printzone.

21. A inkjet printer device comprising a printzone and one or more scanning printheads and first and second input trays, said input trays being arranged in a side by side arrangement and being further arranged such that a sheet may be fed from said first input tray to said print zone at substantially the same time as a sheet is be fed from said second input tray to said print zone.

22. A method of printing using a printer comprising a print zone and first and second media input trays, the method comprising the steps of:
feeding first and second sheets of print media to said printzone from said first and second trays respectively; and,
printing on said first and second sheets substantially simultaneously.

23. A method according to claim 22, wherein said first and second sheets of print media are fed to said printzone substantially simultaneously.

24. A method according to claim 22, wherein said printing step comprises the step of scanning a scanning printhead over said first and second sheets.

25. A method according to claim 24, wherein said printing step further comprises the step of scanning said scanning printhead over said first sheet and then over said second sheet in a repeating fashion.

26. A method according to claim 22, further comprising the step of generating a control instruction in said printer, such that a sheet is selectively fed from either said first or said second input tray or both of said first and said second input trays during the next feed cycle.

27. A method according to claim 26, further comprising the step of receiving at the printer a user input, said control instruction being generated in response to said user input.

28. A method according to claim 26, further comprising the step of receiving a print job at the printer, said control instruction being generated in response to data contained in said print job.

29. A computer program comprising program code means for performing the method steps of any one of claims 22 to 28 when said program is run on a processing means associated with a suitable printer system.
